(19) United States
(12) Patent Application Publication
(10) Pub. No.: US 2006/0086782 A1
(43) Pub. Date: Apr. 27, 2006

(54) Techniques for determining compliance by a manufactuerer with guidelines promulgated by an independent body

(75) Inventor: Martin VanTrieste, Blackhawk, CA (US)

Correspondence Address: EVANS & MOLINELLI, PLLC, U.S. POST OFFICE BOX 7024, FAIRFAX STATION, VA, 22039, US

(73) Assignee: PDA

(21) Appl. No.: 11/250,871

(22) Filed: Oct. 14, 2005

Related U.S. Application Data
(60) Provisional application No. 60/622,540, filed on Oct. 27, 2004.

(51) Int. Cl. G06F 7/00

(52) U.S. Cl. 235/376

(57) ABSTRACT

Techniques for determining compliance with multiple guideline items promulgated in a document for manufacturing a product include receiving data that indicates the multiple guideline items. The guideline items are associated with corresponding compliance fields. Each compliance field holds data that indicates how a particular manufacturer complies with an associated guideline item. Also received is input data that indicates how the particular manufacturer complies with a first guideline item. Compliance data based on the input data is stored in a first compliance field associated with the first guideline item. Based on the compliance data, presentation data is determined. The presentation data is different from both the input data and the compliance data, and more quickly than both indicates to a viewer compliance with the guideline items. The presentation data is displayed for viewing by a reviewer for the particular manufacturer.

### BACKGROUND OF THE INVENTION

1. Field of the Invention

The present invention relates to determining compliance with guidelines promulgated by an independent body, such as a regulatory agency, and in particular to techniques for determining progress in complying with multiple guideline items in a promulgated document.

2. Description of the Related Art

Manufacturers produce products for sale in commerce. Certain products fall under the purview of independent bodies, such as industry standards associations and regulatory bodies. For example, food and drugs for internal use by humans in the United States are regulated by the Food and Drug Administration, charged with ensuring the safety of such items. The regulatory bodies are often empowered to impose restrictions on the manufacturing process. Compliance with such restrictions is mandatory.

In some cases, the restrictions are first proposed as industry guidelines that are considered to represent the best practices for producing a particular product or type of product. It behooves a manufacturer to comply with such guidelines within a reasonable schedule so that if and when the practices become mandatory, manufacturing operations are not impaired, fined, delayed or shut down.

Often the guidelines include a large number of individual guideline elements (called herein “guideline items”). This may occur, for example, when a product is under the purview of multiple agencies which each suggest guidelines to address different considerations. The task of assessing compliance with a large number of guideline items can become overwhelming for a single responsible person. Even if the task is delegated to several responsible persons, when a large number of guideline items are involved compliance is rendered difficult by the large amount of coordination demanded of those individuals. The problem is made worse because the guidelines are established by an outside body that does not know or use the organizational and work breakdown elements that are used in the manufacturer's operations—so the manufacturer must adapt to a guideline organization that does not map easily to its own operations.

The number of guideline items can become burdensome. For example, it has been determined that there are over 450 guideline items among the nonbinding recommendations described in a single document prepared by a group of regulatory bodies in the United States. The particular document is directed to pharmaceutical current good manufacturing practice (CGMP) in aseptic processing and is entitled “Guidance for Industry, Sterile Drug Products Produced by Aseptic Processing—Current Good Manufacturing Practice” and is recently published in September 2004. This particular document has been prepared and promulgated by the U.S. Department of Health and Human Services, the Food and Drug Administration, the Center for Drug Evaluation and Research (CDER), the Center for Biologics Evaluation and Research (CBER) and the Office of Regulatory Affairs (ORA). Copies of the Guidance for Industry are available from the Office of Training and Communication Division of Drug Information, HFD-240 Center for Drug Evaluation and Research Food and Drug Administration, 5600 Fishers Lane, Rockville, Md. 20857 (telephone 301-827-4573, and website in the guidance subdirectory of the cder directory at the world wide website with domain name fda.gov).

Often a manufacturer is not immediately compliant with newly promulgated guidelines, and one or more processes are instituted to move toward compliance with one or more guidelines items. A manager of a manufacturing facility needs to be able to quickly determine the current status of compliance and projected completion of compliance with all the guideline items. Exisiting methods to determine compliance status involve manually checking multiple documents or with multiple persons, or both, to ascertain and report progress each time the current status or projected completion of compliance, or both, is to be determined. When there are hundreds of guideline items, manual processes are time consuming, tedious and error-prone. Reports based on such manual processes are time consuming to review and are often incomplete or inaccurate.

A checklist provided as a table that lists each guideline item could be used in a word processor, but such tables have several disadvantages. One disadvantage is that the description of the guideline item is truncated in the table to leave sufficient room for other table entries. This makes the item hard to understand for the person using the table, especially if the differnce between two guidelines items is subtle and takes many words to describe. Another disadvantage is that the status of each guidance item takes time to review as the reviewer's eyes scan from a column indicating the guideline item to another column that indicates the status of compliance or another column that indicates a process to achieve compliance. It would be preferable for a reviewer to tell at a glance that a particular page of items are met or on schedule for being met.

Another disadvantage of such a table is that the entire table can not be made visible when there are hundreds of guideline items. Typically one page of the table at a time can be viewed, which means that only a small percentage of hundreds of guideline items can be reviewed at a time by a manger. It is a disadvantage that such tables do not give a single quantitiatve measure of the degree of compliance with all the items.

Based on the foregoing there is a clear need for techniques to determine the status of compliance that does not suffer the disadvantages of prior art approaches. In particular, there is a need for techniques to more immediately determine the current status of compliance with multiple guideline items, for identifying the guideline items for which the manufacturer is progressing on a reasonable schedule for achieving compliance, such as achieving compliance on a date before the guidelines become mandatory, and for giving an single overall measure of compliance that reflects the status of hundreds of guideline items.

The past approaches described in this section could be pursued, but are not necessarily approaches that have been previously conceived or pursued. Therefore, unless otherwise indicated herein, the approaches described in this section are not to be considered prior art to the claims in this application merely due to the presence of these approaches in this background section.

### SUMMARY OF THE INVENTION

Techniques are provided for determining compliance with multiple guideline items promulgated in a document for manufacturing a product. The techniques include receiving data that indicates the multiple guideline items. The guideline items are associated with corresponding compliance fields. Each compliance field holds data that indicates how a particular manufacturer complies with an associated guideline item. Also received is input data that indicates how the particular manufacturer complies with a first guideline item. Compliance data based on the input data is stored in a first compliance field associated with the first guideline item. Based on the compliance data, presentation data is determined. The presentation data is different from both the input data and the compliance data, and more quickly than both indicates to a viewer compliance with the guideline items. The presentation data is displayed for viewing by a reviewer for the particular manufacturer.

In some embodiments, the compliance field holds data that indicates whether the particular manufacturer is currently compliant with the associated guideline item. In some embodiments, the compliance field holds data that indicates when the particular manufacturer is due to become compliant with the associated guideline item.

In some embodiments, receiving data that indicates the guideline items for manufacturing a product includes receiving a hyperlink to a portion of document data that represents the document that promulgates a guideline item. The hyperlink is a display element that responds to a viewer's selection by causing the portion of the document data to be displayed. In these embodiments the hyperlink is displayed for viewing by the reviewer for the particular manufacturer.

In some embodiments, the presentation data indicates multiple item colors corresponding to the multiple guideline items. Each item color is based on the compliance data in the compliance field associated with the guideline item that itself is associated with the item color. Displaying the presentation data includes displaying an array of colored cells. The cells in the array correspond to the multiple guidance items and are displayed using the item colors that correspond to the multiple guideline items. Thus, the color in a cell is an item color based on a compliance value associated with a guidance item that is associated with the cell.

In some embodiments, determining the presentation data includes determining summary data that includes a single summary value. The single summary value is determined based on compliance data in compliance fields associated with all of the plurality of guideline items. In some of these embodiments, the summary value indicates a number of the guideline items for which the compliance field includes a particular compliance value, such as a particular value that indicates that the manufacturer is compliant with the associated guideline item. In some of these embodiments, the compliance field holds data that indicates when the manufacturer is due to become compliant, and the summary value indicates a latest date among the guideline items.

These techniques allow a reviewer for the manufacturer to determine the compliance status for multiple guidance items more easily, quickly, accurately or completely, or some combination, than prior art approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates at a high level a method for determining compliance, according to an embodiment;

FIG. 2A is a block diagram that illustrates presentation elements on a computer screen that indicates a spreadsheet formatted for presenting summary data and colored cells based on values in two compliance fields, according to an embodiment;

FIG. 2B is a block diagram that illustrates second presentation elements on a computer screen that indicate a spreadsheet formatted for presenting summary data and colored cells based on values in two compliance fields, according to an embodiment;

FIG. 3 is a block diagram that illustrates cells on a computer screen that are colored based on values in one or more compliance fields, according to an embodiment; and

FIG. 4 is a block diagram that illustrates a computer system upon which an embodiment of the invention may be implemented.

### DETAILED DESCRIPTION

A method and computer-readable medium are described for determining compliance with multiple guideline items promulgated in a document for manufacturing a product. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

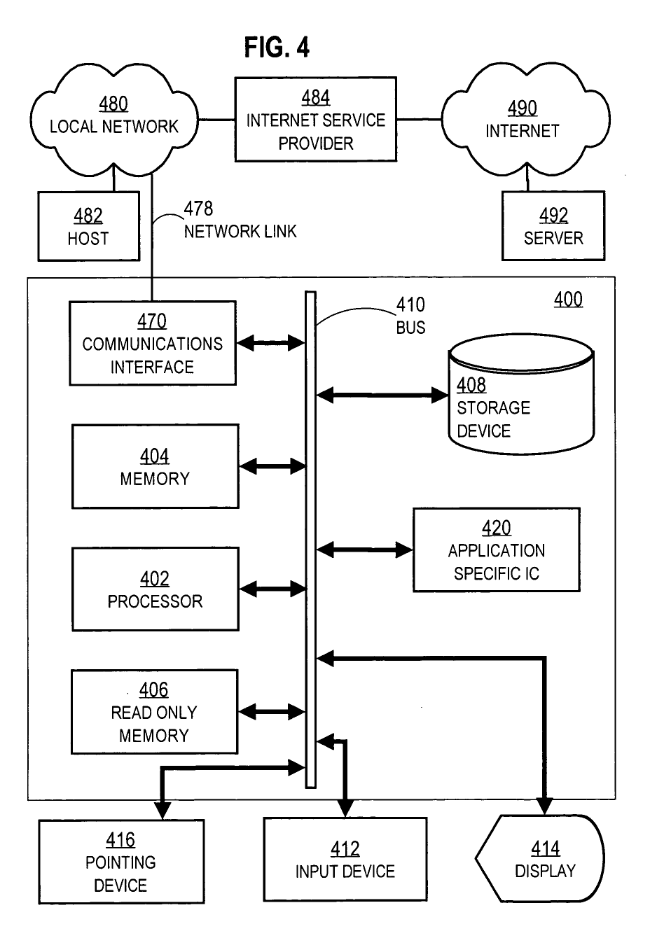

Embodiments of the invention are described in the context of using commercially available computer applications MSWORD™ and MSEXCEL™ from Microsoft Corporation of Redmond Wash. to determine the compliance of a manufacturer with the Guidance for Industry, Sterile Drug Products Produced by Aseptic Processing—Current Good Manufacturing Practice, September 2004, cited above; but, the invention is not limited to this context. In other embodiments, compliance may be determined with the guidelines promulgated in a different document from the same or different bodies using different special purpose or commercially available data processing applications using any combination of hardware and software. Computer hardware and software are described in more detail in a later section with reference to FIG. 4.

### 1. Functional Overview

Various embodiments of the invention employ user inputs to determine compliance for multiple guidance items promulgated in one or more documents and presents one or more displays that more quickly indicate compliance with several guidance items than are indicated by a table or checklist of the guideline items.

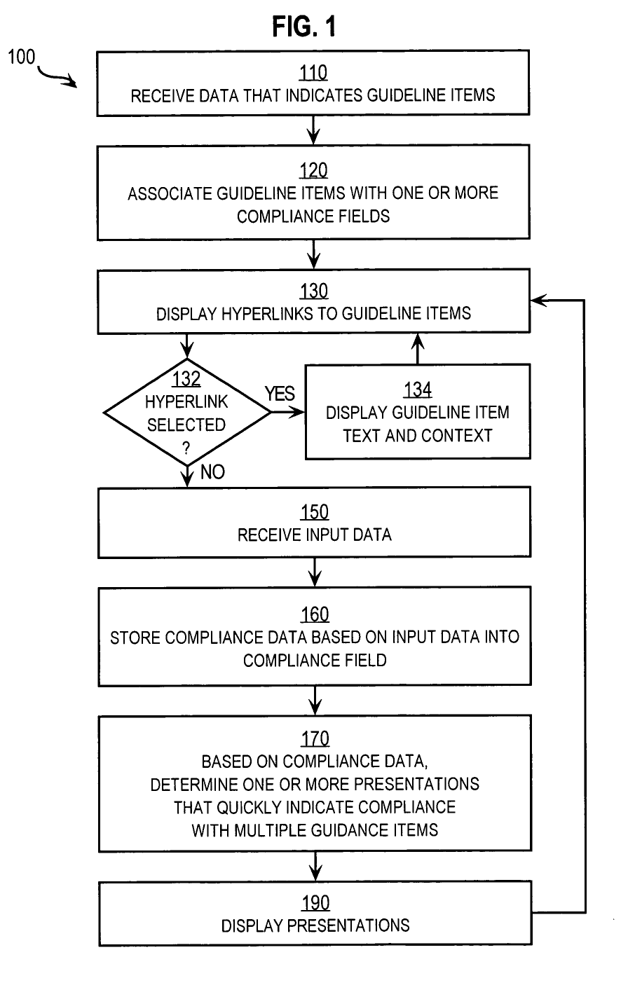

FIG. 1 is a flow diagram that illustrates at a high level a method 100 for determining compliance, according to an embodiment. Although steps are shown in FIG. 1 in a particular order for purposes of illustration, in other embodiments steps may be performed in a different order, or may overlap in time, or may be omitted.

In step 110, data is received that indicates guideline items. Any method known in the art for receiving data may be used, including but not limited to receiving keyed or spoken input from a human user, retrieving data from one or more computer readable media described in more detail in a later section, such as a non-volatile storage device, or some combination. The input from a human user may be in response to a prompt presented to the user or may be unprompted. In some embodiments, step 110 includes receiving a paper document that promulgates multiple guideline items and forming an electronic version of the document using any method known in the art, such as retyping the document in a word processor program or scanning the document and using an optical character recognition application to convert image data into a sequence of codes, such as Unicode, for characters used in the document. In an illustrated embodiment described in more detail below, step 110 includes receiving a link to a portion of a word processor file that stores text data along with format data that indicates how to display the text.

In step 120, each guideline item is associated with one or more compliance fields. Any method known in the art may be used to perform this association, including but not limited to storing the guideline item, or a link to the guideline item, in a database record with the one or more compliance fields in a database, or storing the guideline item or link in the same row or column with a compliance field in an instance of a spreadsheet. A compliance field holds data that indicates how a particular manufacturer complies with an associated guideline item. For example, one or more compliance fields can be selected from Table 1.

TABLE 1
Example Compliance Fields

| Field Name | Field contains data that indicates: |
|---|---|
| Firm | A name for a policy or procedure of the manufacturer |
| Requirement | which involves the guideline item, if any |
| Firm | A list of document references for the policy or |
| Documents | procedure of the manufacturer which involves the |
| | guideline item, if any |
| Actions | A description of actions to be taken by the |
| Required | manufacturer, if any, to move from non-compliance |
| | to compliance with the guideline item |
| Responsible | A person who is responsible for carrying out the |
| Individual | actions required, if any |
| Due Date | A scheduled date for completing the actions |
| | required, if any |
| Date | The date that the actions required are actually |
| Completed | completed, if any |
| Date Status | How the current date compares to the due date |
| Compliance | Whether the manufacturer currently complies with |
| Status | the guideline item |

In step 130, hyperlinks to the guideline items are displayed for a user. A hyperlink is a display element associated with a portion of stored data in a storage unit (e.g., a web page on the Internet or a file on disk). The portion of data may be stored in the same storage unit as the hyperlink or in a different storage unit. A hyperlink responds to a user's selection by causing the portion of data in the storage unit to be displayed. Any method may be used to indicate a user's selection. Typically a user positions a display cursor associated with a pointing device over a display element and presses a key to indicate selection of the display element. In some embodiments, the hyperlink includes text that is descriptive of the portion of stored data and distinctive formatting (such as color and underlining) to distinguish text in the hyperlink from other text on the display. In some embodiments, step 130 is omitted.

In some embodiments, step 130 includes displaying additional display items with the hyperlink for each guideline item. For example, in some embodiments, step 130 includes a display item that uniquely numbers each guideline item and a display item that provides a reference to a section of the document that promulgates the guideline item. In some embodiments, step 130 includes displaying contents for one or more compliance fields.

In step 132 it is determined whether the hyperlink is selected by a user. If so, control passes to step 134. In step 134, the portion of stored data pointed to by the hyperlink is displayed as text that describes the guideline item in context. In some embodiments, step 134 continues for some predetermined time or until a user indicates that the display is no longer desired. After step 134 completes, control passes back to step 130 to display the hyperlink with any additional display items or compliance fields.

If the hyperlink is not selected by the user, control passes to step 150 to receive input data from the user. Any method for receiving the input data may be used, as described above for step 110. For example, input data is keyed in by a human user that indicates the manufacturer is in compliance with a first guidance item and that indicates the manufacturer has instituted certain actions to achieve compliance with a second guidance item within three months.

In step 160, compliance data based on the input data is stored in one or more of the compliance fields for one or more guidance items. For example, a date three months from the present is computed based on the input data and the current date; and the computed date is stored in the Due Date compliance field for the appropriate guidance item.

In step 170, one or more presentations are determined based on the compliance data currently stored in association with the multiple guideline items. The presentations are designed to more quickly indicate compliance with multiple guideline items than having a human eye focus on the contents of the one or more compliance fields for multiple guidance items.

For example, in some embodiments, the presentation involves color coding one or more cells in a spreadsheet to indicate compliance. Any color coding can be used. For example, green can be used to color one or more cells associated with each guidance item with which the manufacturer is compliant. Red can be used to color code one or more cells associated with each guidance item with which the manufacturer is not compliant and for which there is no completion date and for which the due date is past due or there is no due date. Other colors can be used to indicate other states between these two. For example, yellow can be used to color code one or more cells associated with each guidance item with which the manufacturer is not compliant and for which there is no completion date and for which the due date is within the next five days. The human eye can detect color without focusing on the individual contents in each cell, so a page of colored rows are superior to a page of text listings of contents of the compliance fields. The advantage of color is even greater when the human viewer has to transform the contents of the compliance fields to one of the states represented by the colors, such as determining whether actions required are past due and not already completed.

As another example, in some embodiments, the presentation involves a single value that is based on one or more compliance fields for all the guidance items. Any single value that is based on values in one or more compliance fields for all the guidance items may be used. For example, the single value represents the total number of items, or the percentage of all the items, for which the manufacturer is compliant. A human viewer can then tell right away how far the task of achieving compliance has progressed without reviewing each line in a table that may have hundreds of lines.

For purposes of illustration, the Guidance for Industry, Sterile Drug Products Produced by Aseptic Processing—Current Good Manufacturing Practice, September 2004, cited above, is considered. In this illustration one value independent of the compliance fields is the total number of guidance items (e.g., 457 for the cited guidelines). Then a single value that depends on the compliance fields is the number of items for which the compliance status indicates compliance. A compliance field dependent value of 120, when divided by the compliance independent value of 457, indicates that the manufacturer is only about 26% towards full compliance. In some embodiments a single value that depends on the compliance fields is the latest date among all the due date fields. For example a single value representing a latest date of Jan. 1, 2007 indicates that the manufacturer is not scheduled to be fully compliant until Jan. 1, 2007, if all actions proceed on schedule.

In various embodiments, several different single values can be used based on the contents of the compliance fields for all the guidance items. For example, in some embodiments several single values that each depend on at least one compliance field for all the guidance items include two or more of the following: the number of actions that are completed; the number of actions not yet completed; the percentage of actions completed; the number of compliance status fields that indicate compliance; the percent compliant; the number of person hours to complete tasks to achieve compliance; and the latest date among all the due date fields.

In step 190, the presentations determined in step 170 are displayed. For example, in some embodiments, one or more single values based on all the guideline items are displayed. In some embodiments, a spreadsheet with color coded cells is displayed.

### 2. EXAMPLE EMBODIMENTS

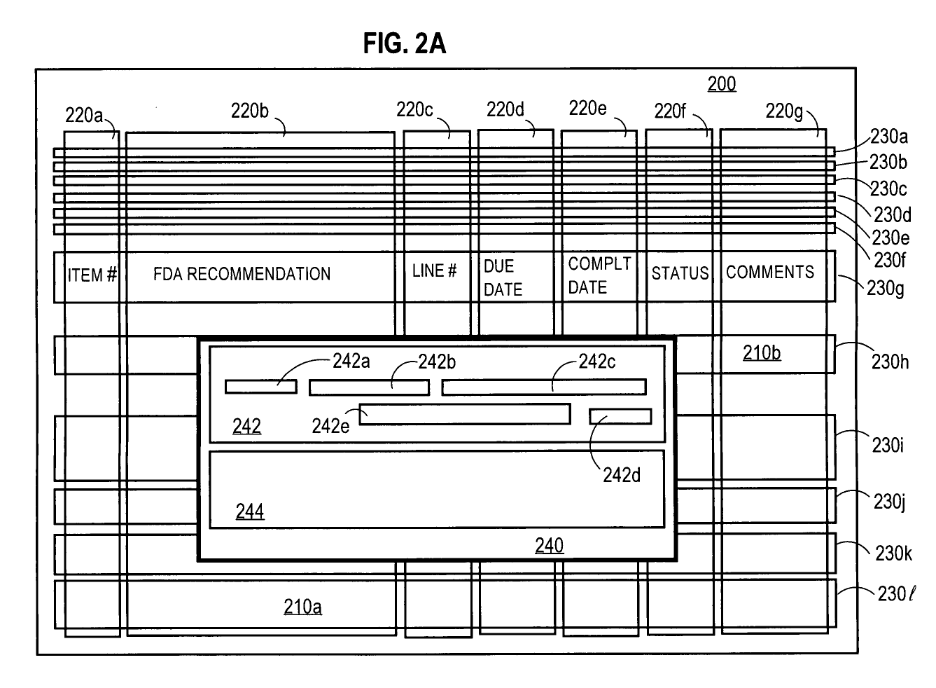

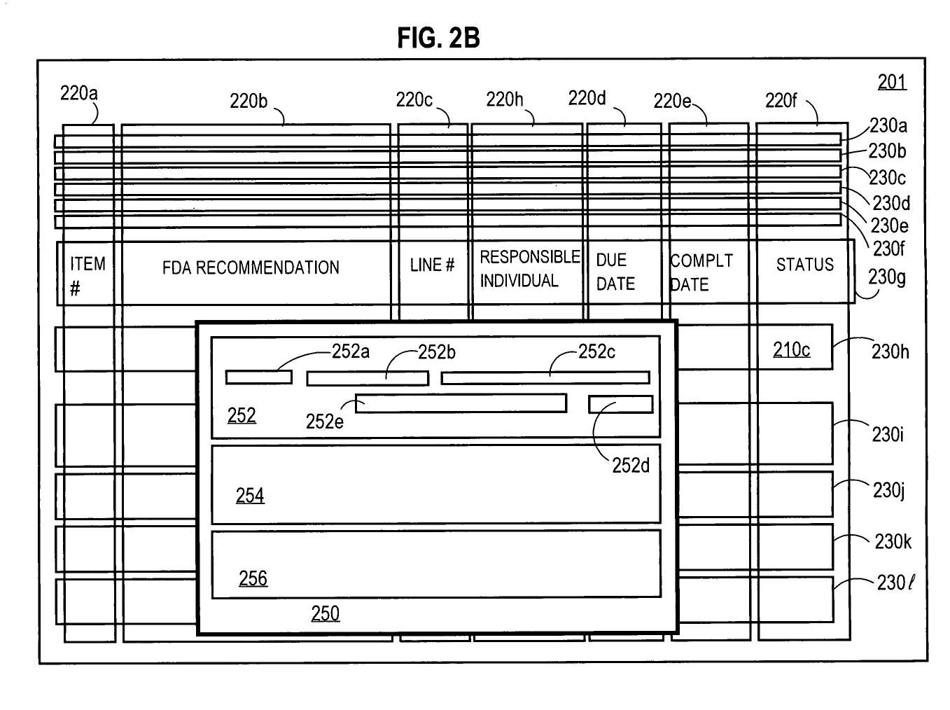

An illustrated embodiment is described here with reference to FIG. 2A and FIG. 2B using MSWORD and MSEXCEL for the Guidance for Industry, Sterile Drug Products Produced by Aseptic Processing—Current Good Manufacturing Practice, September 2004, cited above.

In the illustrated embodiment, all 457 guideline items are in the single document Guidance for Industry, Sterile Drug Products Produced by Aseptic Processing, which is stored as a MSWORD word processing document file. During step 110, hyperlinks to portions of this document file are inserted in an instance of a MSEXCEL spreadsheet file. The portions are manually selected by a person qualified to detect guidance items within the source document. The qualified person runs MSWORD and opens the document file. The qualified person also runs MSEXCEL and opens the instance of the spreadsheet file. In the MSWORD document, the qualified person selects a portion of the displayed text that is judged to constitute a guidance item and selects the copy command from the MSWORD toolbar. In the MSEXCEL spreadsheet instance, the cell that is to store the hyperlink is selected, the MSEXCEL command “Edit” is selected from the tool bar, and the “Paste as Hyperlink” command is selected from the pull down menu. As a result, a hyperlink to the MSWORD document file is stored in the cell of the spreadsheet instance. The hyperlink appears as underlined blue text in a cell of the spreadsheet instance. The process is repeated for each additional guideline item, placing the hyperlink in a subsequent row of the spreadsheet instance.

Subsequent users perform step 110 simply by opening the MSEXCEL spreadsheet instance, because the hyperlink data that indicates the guideline items are received from the spreadsheet file where those data are already stored.

FIG. 2A is a block diagram of first presentation elements on a computer screen 200 that illustrates an MSEXCEL spreadsheet formatted for presenting summary data and colored cells based on values in three compliance fields, according to the illustrated embodiment. The screen 200 displays a first window that includes multiple cells (e.g., 210a, 210b, and collectively referenced hereinafter as cells 210) of the spreadsheet arranged in rows and columns, and displays a second window 240. The columns include columns 220a, 220b, 220c, 220d, 230e, 230f, 230g and are collectively referenced hereinafter as columns 220. The rows include rows 230a, 230b, 230c, 230d, 230e, 230f, 230g, 230h, 230i, 230j, 230k, 230l and are collectively referenced hereinafter as rows 230. These display items are described in more detail below.

Hyperlinks to the MSWORD document appear in FIG. 2A in the cells in rows 230h, 230i, 230j, 230k, 230l of column 220b, including cell 210a. The hyperlink in cell 210a is displayed on a computer screen as blue underlined text that reads “An adequate aseptic processing facility monitoring program also will assess conformance with specified clean area classifications under dynamic conditions on a routine basis,” taken from the source MSWORD document. If a user selects this hyperlink, for example, by positioning a cursor using a mouse pointing device and clicking one of the mouse buttons, the programs will displace screen 200 with a new screen that displays a portion of the MSWORD document where the quoted text is found. This provides more complete text and a context for the guideline item.

In step 120, the guideline items are associated with one or more compliance fields. In FIG. 2A, four compliance fields are found in columns 220d, 220e, 220f, 220g, respectively, as labeled in row 230g. Each guideline item in rows 230h and following is associated with these four compliance fields (as well as other compliance fields, not shown in FIG. 2A) by sharing a row with these columns. These compliance fields are labeled in row 230g as Due Date, Date Completed, Status (which corresponds to Date Status in Table 1) and Comments (which corresponds to Compliance Status in Table 1.) Other compliance fields listed in Table 1 are associated with each guideline item in the illustrated embodiment in other columns of this spreadsheet instance, but those columns are hidden using display options in MSEXCEL to hide some columns.

In step 130, the hyperlinks to guideline items are displayed, as depicted, for example, in FIG. 2A. In the illustrated embodiment, step 130 includes displaying additional display items with the hyperlink for each guideline item, including an item number in column 220a and a Food and Drug Administration (FDA) document line number (e.g., a line number in the MSWORD document) in column 220c for rows 230h and later. In the illustrated embodiment, step 130 includes displaying contents for one or more compliance fields, including the contents of compliance fields in columns 220d, 220e, 220f, 220g.

In steps 132 and 134 portions of the source document are displayed if a user activates a hyperlink, as described above for the hyperlink in cell 210a.

In step 150, input data is received. In the illustrated embodiment, a user keys in values for one or more of the cells in a compliance field column. For example the user types in a value for the comments (Compliance Status) field for the first guidance item by selecting cell 210b in column 220g of row 230h and pressing keys on a keyboard. For purposes of illustration, it is assumed that a user types in “Does not comply” as a text string. Similarly, the user enters data in other compliance fields in the same row 230h for the associated guideline item. For example the user types in text in an Actions Required field and Responsible Individual field in columns that are not shown, and types a due date for completing the actions in the Due Date field in column 220d of row 230h.

In step 160 compliance data is stored based on the input data. In some embodiments the data stored is the same as the data entered; in some embodiments the data stored is derived from the data entered; and in some embodiments both occur. In the illustrated embodiment, the data stored is the same as the data entered for the Actions Required field, Responsible Individual field, Due Date field (column 220d), Date Completed field (column 220e), and Compliance Status (Comments) field (column 220g). However, in the illustrated embodiment, the data stored in the Date Status field (column 220f) is based on the difference between the date in the Due Date field (column 220d) and the current date known to the system and the contents of the Date Completed field (column 220e). If no data is entered in the Date Completed field (column 220e), then a value for the Date Completed field is determined based on the current date and the contents of the Due Date field.

If the user does not enter a date in the Date Completed field (column 220e), the compliance value for this field is based on the input values in the Due Date field. The compliance value in the Date Completed field (column 220e) is “Open” if no due date is set or if a due date is set that is five days or more after the current date. This value is in FIG. 2A in column 220f of row 230l. The compliance value in the Date Completed field (column 220e) is “Within 5 Days” if a due date is set that is not before the current date and is less than five days after the current date. The compliance value in the Date Completed field (column 220e) is “Past Due” if a due date is set that is before the current date.

Formulas in MSEXCEL use cell references designated by a lettered column and numbered row. Formulas can be copied to operate on successive rows and columns because MSEXCEL automatically increments the rows and columns of the cell references. When a cell row or column is not to be incremented as the formula is copied, the row number or column letter should be preceded by “$”. Formula f1 is given for the first row (230h) of guideline items, which is the tenth row of the spreadsheet. The Due Date column (220d) is column H. The current date and time is determined in cell M2. The compliance value displayed in the Date Completed field is determined in the illustrated embodiment using the MSEXCEL formula, labeled f1
=IF($H10=””, ““, IF($H10<$M$2, “PAST DUE”, IF($H10=$M$2, “Within 5 Days”, IF($H10=$M$2+1, “Within 5 Days”, IF($H10=$M$2+2, “Within 5 Days”, IF($H10=$M$2+3, “Within 5 Days”, IF($H10=$M$2+4, “Within 5 Days”, IF($H10>$M$2, “Open”)))))))) (f1)

The compliance value in the Date Status field (column 220f) is “Open” if there are required actions yet to be completed and is “Complete” if the required actions have been completed. The action is complete if there is a value other than “Open,” “Within 5 Days,” and “Past Due” in the Date Completed field (column 220e), which is the Ith column in the spreadsheet. The compliance value in the Date Status field (column 220f) is determined using the following MSEXCEL formula, given as formula f2.
=IF(I10=””, “Open”, IF(I10=“Past Due”, “Open”, IF(I10=“Within 5 Days”, “Open”, IF(I10=“Open”, “Open”, “Complete”)))) (f2)

In step 170, presentations are determined that more quickly indicate the compliance of multiple guideline items. In the illustrated embodiment, both colored cells and summary values derived from one or more compliance fields for all the guideline items are used to quickly indicate compliance with multiple guideline items.

In the illustrated embodiment, five summary values are computed based on the contents of one or more compliance fields in all guideline items: the number of action items completed, the number of action items not yet completed, the percent of actions completed, the number of requirements compliant, and the percent compliant, as indicated in rows 230b, 230c, 230d, 230e, 230f, respectively, by labels in column 220b and values in column 220a.

TABLE 2
Example summary values and labels

| Value | Label |
|---|---|
| 457 | # recommendations within the Guidance |
| 0 | action items completed |
| 457 | action items not yet completed |
| 0.0% | percent of actions completed |
| 0 | requirements compliant |
| 0.0% | percent compliant |

The value in row 230a, labeled number of recommendations within the Guidance, is not based on the compliance fields, but simply sums the number of rows that are associated with guideline items. The value in column 220a for this parameter is 457 as shown in row 230a. This value is computed in some embodiments by using the MSEXCEL count formula to count the non blank entries in column 220a in all rows after 230h (MSEXCEL row 10).

The value in column 220a for row 230b indicates the number of actions required that have been completed. This value is computed using MSEXCEL formula f3
=COUNTIF($J$10:$J$661, “Complete”) (f3)
which increments a count if the contents equal “Complete” in the cell range from J10 to J661 (the total row extent of the spreadsheet) corresponding to the compliance Date Status field (column 220f).

The value in column 220a for row 230c indicates the number of required actions yet to be completed. This value is computed using MSEXCEL formula f4
=+$A$1−A2 (f4)
which subtracts the actions that are complete from the total number of requirements. In other embodiments, other formulae are used. For example, if some guidance items do not require actions, as indicted by blanks in the Actions Required column, MSEXCEL column F, then such items are not considered actions yet to be completed. In this embodiment an appropriate formula is given by f5.
=$A$1−COUNTIF($F$10:$F$661, “ ”)−A2 (f5)

The value in column 220a for row 230d indicates the percentage of required actions that have been completed. This value is computed using MSEXCEL formula f6
=+A2/$A$1 (f6)
Again, if some guideline items do not require actions, then such items are not considered in the denominator. In this embodiment an appropriate formula is given by f7.
=+A2/($A$1−COUNTIF($F$10:$F$661, “ ”)) (f7)

The value in column 220a for row 230e indicates the number of guideline items with which the manufacturer is currently compliant. This value is computed using MSEXCEL formula f8.
=COUNTIF($K$10:$K$661, “Complies”) f(8)
which increments a count if the contents equal “Complies” in the cell range from K10 to K661 corresponding to the Compliance Status field (column 220g).

The value in column 220a for row 230f indicates the percentage of all guideline items for which the manufacturer is compliant. This value is computed using MSEXCEL formula f9
=+A5/$A$1 (f9)

In the illustrated embodiment, the cells in certain of the compliance fields are colored based on the values in those fields. The certain compliance fields, called hereinafter the “colored compliance fields,” are the Date Completed Field (column 220e), the Date Status field (column 220f) and the Compliance Status field (column 220g, also called the Comments field). A cell in the Date Completed field (column 220e) is colored red if the value therein is “Past Due;” is colored yellow if the value therein is “Within 5 Days;” and is left uncolored otherwise. A cell in the Date Status field (column 220f) is colored green if the value therein is “Completed;” and is left uncolored otherwise (e.g., when the value therein is “Open”). A cell in the Compliance Status field (column 220g) is colored green if the value therein is “Complies;” is colored red if the value therein is “Does Not Comply;” and is left uncolored otherwise (e.g., when the value therein is blank). In other embodiments, other color schemes are used. In the illustrated embodiment, these fields are colored using conditional formatting in the MSEXCEL spreadsheet.

FIG. 2A depicts conditional formatting for the cell 210b in the Compliance Status field (column 220g) in window 240. These conditional formats may be copied to this column in every row associated with a guideline item or may be applied to the entire spreadsheet instance. A conditional formatting window is opened by selecting the EXCEL tool bar item “Format” and selecting the pull down menu item “Conditional Formatting.” Conditional formatting window 240 includes multiple panels 242, 244 for specifying multiple conditions that change the formatting of this cell. Panel 242 specifies a first condition for formatting a cell. A panel is added or removed from the window using the Add or Delete buttons along the bottom of the window 240. In pull down list 242a the basis of the condition is selected; either the formula or the result of the formula can be selected as the basis. In the illustrated embodiment the value produced by a formula or a constant value input into the field is used as the basis for the condition. In pull down list 242b the relationship of the condition is selected; equality and non-equality relationships may be selected. In the illustrated embodiment the “equal to” relationship is selected. In field 242c the value is entered which is to be compared to the basis. The format button 242d is used to bring up formatting options for the cell which are to be applied if the condition is satisfied. The options allow a font, style, size, and background color to be selected. The selected format is depicted in field 242e. In the illustrated embodiment, panel 242 is used to set the background color to green if the value in a cell equals “Complies.” Panel 244 is used to set the background color to red if the value in a cell equals “Does Not Comply.”

FIG. 2B is a block diagram that illustrates second presentation elements on a computer screen 201 that illustrates a spreadsheet formatted for presenting summary data and colored cells based on values in three compliance fields, according to an embodiment. In the screen 201 an additional column 220h is displayed and another column 220g in FIG. 2A is omitted. Column 220h provides a Responsible Individual field as another compliance field.

FIG. 2B depicts conditional formatting window 250 for the cell 210c in the Date Status field (column 220f). These conditional formats may be copied to this column in every row associated with a guideline item. In the illustrated embodiment, the same conditional formats are used in the Date Completed field (column 220e). Conditional formatting window 250 includes multiple panels 252, 254, 256 for specifying multiple conditions that change the formatting of this cell. Panel 252 specifies a first condition for formatting a cell using pull down lists 252a, 252b, value field 252c, format button 252d, and displayed format field 252e, as described above for panel 242. In the illustrated embodiment, panel 252 is used to set the background color to red if the value in a cell equals “Past Due.” Panel 254 is used to set the background color to green if the value in a cell equals “Complete.” Panel 256 is used to set the background color to yellow if the value in a cell equals “Within 5 Days.”

Using different colored cells in one or more compliance fields to indicate different values or ranges of values, compliance for multiple guideline items can be discerned at a glance, thus improving the review of compliance status by a reviewer for the manufacturer.

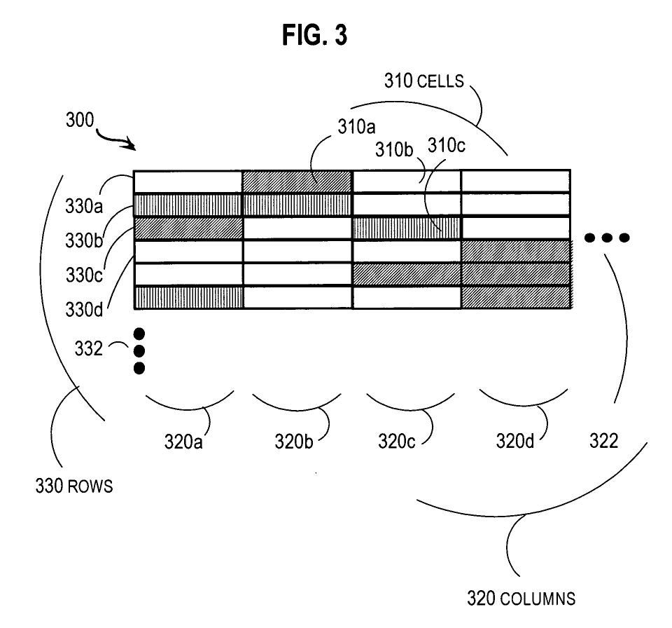

FIG. 3 is a block diagram that illustrates a presentation using cells on a computer screen 300 that are colored based on values in one or more compliance fields, according to an embodiment. Screen 300 includes multiple cells 310 arranged in rows 330 and columns 320. Cells 310 include cells 310a, 310b, 310c, among others depicted and not depicted. Rows 330 include rows 330a, 330b, 330c, 330d, among others depicted and ellipsis 332 represents additional rows of cells that are not depicted. Columns 320 include columns 320a, 320b, 320c, 320d, and ellipsis 322 represents additional columns of cells that are not depicted.

Cells 310 correspond to guideline items. In some embodiments, as described above with reference to FIGS. 2A and 2B, each guideline item corresponds to one row of cells, and different columns in the same row represent different fields to hold compliance data associated with each guideline item.

In other embodiments, each guideline item corresponds to another grouping of cells, such as a column of cells or a rectangular area of cells. The cell may be any size from one screen picture element (pixel) to hundreds or thousands of pixels. The cells may be any shape, including rectangular shapes, as shown, squares, circles, or oval shapes. Different cells may be different shapes. The color of at least one cell in the group indicates compliance of the manufacturer with the corresponding guideline item, as described above for the spreadsheet instance.

In a particular embodiment, each guideline item corresponds to a single cell, every cell is square, and the cells are sized so that cells for all guideline items are visible on the screen 300 at the same time. For example, the 457 guideline items of the cited reference are represented by 457 square cells arranged in 18 rows of 25 columns of cells and a 19^{th} row with 7 columns. In this embodiment, the color of the cell indicates compliance of the manufacturer with the corresponding guideline item. A color scheme can be used that indicates the most important aspects of compliance. For example, the following color scheme is used in the particular embodiment. Red indicates a guideline item for which the manufacturer is not compliant and has not identified any action to become compliant. Orange indicates a guideline item for which the manufacturer is not compliant but action has been identified to be completed by a due date that is past due. Yellow indicates a guideline item for which the manufacturer is not compliant but action has been identified to be completed by a due date that is coming soon (e.g., within 5 days). Brown indicates a guideline item for which the manufacturer is not compliant but action has been identified to be completed by a due date that is still distant (e.g., greater than 5 days). Green indicates a guideline item for which the manufacturer is currently compliant, for example because an action has been identified and completed.

Using this embodiment, a reviewer can quickly tell from a single screen the degree of compliance with all the guideline items. For example, cell 310a is orange, indicating a past due action, cell 310b is yellow indicating an action coming due within 5 days, and cell 310c is green indicating compliance with the corresponding guideline item.

In some embodiments, a viewer can move a cursor and click on a colored cell to hyperlink to a row in the spreadsheet (e.g., row 230k in FIG. 2A) or a portion of the source document that corresponds to the guideline item that corresponds to the cell.

### 3. Hardware Overview

FIG. 4 is a block diagram that illustrates a computer system 400 upon which an embodiment of the invention may be implemented. Computer system 400 includes a communication mechanism such as a bus 410 for passing information between other internal and external components of the computer system 400. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). A sequence of binary digits constitutes digital data that is used to represent a number or code for a character. A bus 410 includes many parallel conductors of information so that information is transferred quickly among devices coupled to the bus 410. One or more processors 402 for processing information are coupled with the bus 410. A processor 402 performs a set of operations on information. The set of operations include bringing information in from the bus 410 and placing information on the bus 410. The set of operations also typically include comparing two or more units of information, shifting positions of units of information, and combining two or more units of information, such as by addition or multiplication. A sequence of operations to be executed by the processor 402 constitute computer instructions.

Computer system 400 also includes a memory 404 coupled to bus 410. The memory 404, such as a random access memory (RAM) or other dynamic storage device, stores information including computer instructions. Dynamic memory allows information stored therein to be changed by the computer system 400. RAM allows a unit of information stored at a location called a memory address to be stored and retrieved independently of information at neighboring addresses. The memory 404 is also used by the processor 402 to store temporary values during execution of computer instructions. The computer system 400 also includes a read only memory (ROM) 406 or other static storage device coupled to the bus 410 for storing static information, including instructions, that is not changed by the computer system 400. Also coupled to bus 410 is a non-volatile (persistent) storage device 408, such as a magnetic disk or optical disk, for storing information, including instructions, that persists even when the computer system 400 is turned off or otherwise loses power.

Information, including instructions, is provided to the bus 410 for use by the processor from an external input device 412, such as a keyboard containing alphanumeric keys operated by a human user, or a sensor. A sensor detects conditions in its vicinity and transforms those detections into signals compatible with the signals used to represent information in computer system 400. Other external devices coupled to bus 410, used primarily for interacting with humans, include a display device 414, such as a cathode ray tube (CRT) or a liquid crystal display (LCD), for presenting images, and a pointing device 416, such as a mouse or a trackball or cursor direction keys, for controlling a position of a small cursor image presented on the display 414 and issuing commands associated with graphical elements presented on the display 414.

In the illustrated embodiment, special purpose hardware, such as an application specific integrated circuit (IC) 420, is coupled to bus 410. The special purpose hardware is configured to perform operations not performed by processor 402 quickly enough for special purposes. Examples of application specific ICs include graphics accelerator cards for generating images for display 414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 400 also includes one or more instances of a communications interface 470 coupled to bus 410. Communication interface 470 provides a two-way communication coupling to a variety of external devices that operate with their own processors, such as printers, scanners and external disks. In general the coupling is with a network link 478 that is connected to a local network 480 to which a variety of external devices with their own processors are connected. For example, communication interface 470 may be a parallel port or a serial port or a universal serial bus (USB) port on a personal computer. In some embodiments, communications interface 470 is an integrated services digital network (ISDN) card or a digital subscriber line (DSL) card or a telephone modem that provides an information communication connection to a corresponding type of telephone line. In some embodiments, a communication interface 470 is a cable modem that converts signals on bus 410 into signals for a communication connection over a coaxial cable or into optical signals for a communication connection over a fiber optic cable. As another example, communications interface 470 may be a local area network (LAN) card to provide a data communication connection to a compatible LAN, such as Ethernet. Wireless links may also be implemented. For wireless links, the communications interface 470 sends and receives electrical, acoustic or electromagnetic signals, including infrared and optical signals, that carry information streams, such as digital data. Such signals are examples of carrier waves.

The term computer-readable medium is used herein to refer to any medium that participates in providing information to processor 402, including instructions for execution. Such a medium may take many forms, including, but not limited to, non-volatile media, volatile media and transmission media. Non-volatile media include, for example, optical or magnetic disks, such as storage device 408. Volatile media include, for example, dynamic memory 404. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Network link 478 typically provides information communication through one or more networks to other devices that use or process the information. For example, network link 478 may provide a connection through local network 480 to a host computer 482 or to equipment 484 operated by an Internet Service Provider (ISP). ISP equipment 484 in turn provides data communication services through the public, world-wide packet-switching communication network of networks now commonly referred to as the Internet 490. A computer called a server 492 connected to the Internet provides a service in response to information received over the Internet. For example, server 492 provides information representing video data for presentation at display 414.

The invention is related to the use of computer system 400 for implementing the techniques described herein. According to one embodiment of the invention, those techniques are performed by computer system 400 in response to processor 402 executing one or more sequences of one or more instructions contained in memory 404. Such instructions, also called software and program code, may be read into memory 404 from another computer-readable medium such as storage device 408. Execution of the sequences of instructions contained in memory 404 causes processor 402 to perform the method steps described herein. In alternative embodiments, hardware, such as application specific integrated circuit 420, may be used in place of or in combination with software to implement the invention. Thus, embodiments of the invention are not limited to any specific combination of hardware and software.

The signals transmitted over network link 478 and other networks through communications interface 470, which carry information to and from computer system 400, are exemplary forms of carrier waves. Computer system 400 can send and receive information, including program code, through the networks 480, 490 among others, through network link 478 and communications interface 470. In an example using the Internet 490, a server 492 transmits program code for a particular application, requested by a message sent from computer 400, through Internet 490, ISP equipment 484, local network 480 and communications interface 470. The received code may be executed by processor 402 as it is received, or may be stored in storage device 408 or other non-volatile storage for later execution, or both. In this manner, computer system 400 may obtain application program code in the form of a carrier wave.

Various forms of computer readable media may be involved in carrying one or more sequence of instructions or data or both to processor 402 for execution. For example, instructions and data may initially be carried on a magnetic disk of a remote computer such as host 482. The remote computer loads the instructions and data into its dynamic memory and sends the instructions and data over a telephone line using a modem. A modem local to the computer system 400 receives the instructions and data on a telephone line and uses an infra-red transmitter to convert the instructions and data to an infra-red signal, a carrier wave serving as the network link 478. An infrared detector serving as communications interface 470 receives the instructions and data carried in the infrared signal and places information representing the instructions and data onto bus 410. Bus 410 carries the information to memory 404 from which processor 402 retrieves and executes the instructions using some of the data sent with the instructions. The instructions and data received in memory 404 may optionally be stored on storage device 408, either before or after execution by the processor 402.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for determining compliance with multiple guideline items promulgated in a document for manufacturing a product, the method comprising the steps of:
receiving data that indicates a plurality of guideline items for manufacturing a product;
associating with the plurality of guideline items a corresponding plurality of compliance fields, wherein each compliance field holds data that indicates how a particular manufacturer complies with an associated guideline item;
receiving input data that indicates how the particular manufacturer complies with a first guideline item of the plurality of guideline items;
storing in a first compliance field associated with the first guideline item compliance data based on the input data;
determining, based on the compliance data, presentation data different from both the input data and the compliance data, wherein the presentation data more quickly indicates to a viewer compliance with the plurality of guideline items than does the compliance data; and
displaying the presentation data for viewing by a reviewer for the particular manufacturer.

2. The method as recited in claim 1, wherein the compliance field holds data that indicates whether the particular manufacturer is currently compliant with the associated guideline item.

3. The method as recited in claim 1, wherein the compliance field holds data that indicates when the particular manufacturer is due to become compliant with the associated guideline item.

4. The method as recited in claim 1, wherein:
said step of receiving data that indicates a plurality of guideline items for manufacturing a product further comprising receiving a hyperlink to a portion of document data that represents a document that promulgates a guideline item;
the method further comprises displaying the hyperlink for viewing by the reviewer for the particular manufacturer; and
the hyperlink is a display element that responds to a viewer's selection by causing the portion of the document data to be displayed.

5. The method as recited in claim 1, wherein:
said step of determining the presentation data further comprises determining a corresponding plurality of item colors for the plurality of guideline items;
each item color is based on the compliance data in the compliance field associated with the guideline item associated with the item color; and
said step of displaying the presentation data further comprises displaying an array of colored cells that correspond to the plurality of guideline items using the corresponding plurality of item colors.

6. The method as recited in claim 1, said step of determining the presentation data further comprising the steps of:
determining summary data that includes a single summary value; and
determining the single summary value based on compliance data in compliance fields associated with all of the plurality of guideline items.

7. The method as recited in claim 6, said step of determining the single summary value further comprises determining the summary value that indicates a number of the guideline items for which the compliance field includes a particular compliance value.

8. The method as recited in claim 7, wherein the particular compliance value indicates that the manufacturer is compliant with the associated guideline item.

9. The method as recited in claim 7, wherein the particular compliance value indicates that the manufacturer has identified action to become compliant with the associated guideline item.

10. The method as recited in claim 6, wherein:
the compliance field holds data that indicates when the manufacturer is due to become compliant with the associated guideline item; and
said step of determining the single summary value further comprises determining the summary value that indicates a latest date among the guideline items.

11. The method as recited in claim 1, wherein the compliance data is the same as the input data.

12. The method as recited in claim 1, wherein the compliance data is different from the input data.

13. A computer-readable medium carrying one or more sequences of instructions for determining compliance with multiple guideline items promulgated in a document for manufacturing a product, wherein execution of the one or more sequences of instructions by one or more processors causes the one or more processors to perform the steps of:
receiving data that indicates a plurality of guideline items for manufacturing a product;
associating with the plurality of guideline items a corresponding plurality of compliance fields, wherein each compliance field holds data that indicates how a particular manufacturer complies with an associated guideline item;
receiving input data that indicates how the particular manufacturer complies with a first guideline item of the plurality of guideline items;
storing in a first compliance field associated with the first guideline item compliance data based on the input data;
determining, based on the compliance data, presentation data different from both the input data and the compliance data, wherein the presentation data more quickly indicates to a viewer compliance with the plurality of guideline items than does the compliance data; and
displaying the presentation data for viewing by a reviewer for the particular manufacturer.

14. The computer-readable medium as recited in claim 13, wherein the compliance field holds data that indicates whether the particular manufacturer is currently compliant with the associated guideline item.

15. The computer-readable medium as recited in claim 13, wherein the compliance field holds data that indicates when the particular manufacturer is due to become compliant with the associated guideline item.

16. The computer-readable medium as recited in claim 13, wherein:
said step of receiving data that indicates a plurality of guideline items for manufacturing a product further comprising receiving a hyperlink to a portion of document data that represents a document that promulgates a guideline item;
execution of the one or more sequences of instructions further causes the one or more processors to perform the step of displaying the hyperlink for viewing by the reviewer for the particular manufacturer; and
the hyperlink is a display element that responds to a viewer's selection by causing the portion of the document data to be displayed.

17. The computer-readable medium as recited in claim 13, wherein:
said step of determining the presentation data further comprises determining a corresponding plurality of item colors for the plurality of guideline items;
each item color is based on the compliance data in the compliance field associated with the guideline item associated with the item color; and
said step of displaying the presentation data further comprises displaying an array of colored cells that correspond to the plurality of guideline items using the corresponding plurality of item colors.

18. The computer-readable medium as recited in claim 13, said step of determining the presentation data further comprising the steps of:
determining summary data that includes a single summary value; and
determining the single summary value based on compliance data in compliance fields associated with all of the plurality of guideline items.

19. The computer-readable medium as recited in claim 18, said step of determining the single summary value further comprises determining the summary value that indicates a number of the guideline items for which the compliance field includes a particular compliance value.

20. The computer-readable medium as recited in claim 19, wherein the particular compliance value indicates that the manufacturer is compliant with the associated guideline item.

21. The computer-readable medium as recited in claim 19, wherein the particular compliance value indicates that the manufacturer has identified action to become compliant with the associated guideline item.

22. The computer-readable medium as recited in claim 18, wherein:
the compliance field holds data that indicates when the manufacturer is due to become compliant with the associated guideline item; and
said step of determining the single summary value further comprises determining the summary value that indicates a latest date among the guideline items.

23. The computer-readable medium as recited in claim 13, wherein the compliance data is the same as the input data.

24. The computer-readable medium as recited in claim 13, wherein the compliance data is different from the input data.
